(19) United States
(12) Patent Application Publication
(10) Pub. No.: US 2007/0279676 A1
(43) Pub. Date: Dec. 6, 2007

(54) System and method for pipelined dataflow document processing

(75) Inventor: Man Mohan Garg, Cerritos, CA (US)

Correspondence Address: TUCKER ELLIS & WEST LLP, 1150 HUNTINGTON BUILDING, 925 EUCLID AVENUE, CLEVELAND, OH, 44115-1414, US

(73) Assignees: Kabushiki Kaisha Toshiba; Toshiba Tec Kabushiki Kaisha

(21) Appl. No.: 11/447,348

(22) Filed: Jun. 6, 2006

(51) Int. Cl. G06F 3/12

(52) U.S. Cl. 358/1.15

(57) ABSTRACT

A system and method for pipelined dataflow document processing is provided. Job data is first received by a document processing device, inclusive of electronic document and a requested document processing operation. The operation is then divided into a sequence of discrete stages, with each stage representing one process in the requested document processing operation. The first stage is initiated and a determination is made whether one or more additional stages are capable of being performed concurrently with the first stage. When contemporaneous processing is available, the stages are initiated and processing ensues. A determination is then made whether or not any additional stages remain for processing. When additional stages remain, a determination is made whether the data requires for the next stage is available and whether the capacity exists to perform the processing. When both conditions are met, the data is moved to the next stage and the operation continues from there.

### BACKGROUND OF THE INVENTION

The subject application is directed to a system and method for pipelined dataflow document processing. In particular, the subject application is directed to a system and method for synchronized parallel pipelined document processing wherein such processing is more efficient and more fault tolerant.

A multifunctional peripheral device or other type of document processing device typically contains various processing agents or components that process image data from one form to a different form before it is delivered to the user. For performance considerations, it is important to link the data from one processing agent to another processing agent in the most efficient way without any latency between the agents. In addition, the data should be transferred to a processing agent in a continuous fashion as it becomes available from the previous agent without any delay. Another option is to split image processing into planes that may be separately processed. These planes require parallel processing pipelines that have the ability to run out of phase from each other as well as the ability to merge the processing at some stage to generate the final output.

Existing processing systems consist of serial pipeline processing with filters to process the data as it passes by the pipeline. In addition, there is no ability to split the data at some stages of the processing and merge it together at a later stage to allow parallel processing. The pipelines are created using a conventional storage mechanism comprising one reading mechanism and one writing mechanism. Further, the pipelines have no ability to signal the filters when the data has been processed and that such pipeline has the ability to receive additional data. Also, current systems are not fault or interrupt tolerant, and are required to re-commence a document processing operation in the event that a job is interrupted in the midst of a pipelined processing. It would be advantageous to have a pipelined document processing system and method that is robust and can recover from interrupts, as well as efficiently use parallel processing in an efficient manner.

The subject application overcomes the above mentioned problems and provides a system and method pipelined dataflow document processing.

### SUMMARY OF THE INVENTION

In accordance with the subject application, there is provided a system and method for pipelined dataflow document processing.

Further, in accordance with the subject application, there is provided a system and method for synchronized parallel pipelined document processing wherein such processing is more efficient and more fault tolerant.

Still further, in accordance with the subject application, there is provided a system and method for pipelined dataflow document processing that is robust and can recover from interrupts, as well as efficiently use parallel processing in an efficient manner.

Still further, in accordance with the subject application, there is provided a system for pipelined dataflow document processing. The system includes means adapted for receiving job data inclusive of at least one electronic document directed to processing on a selected document processing device and a processing pipeline adapted for processing each received electronic document in a series of discrete processing stages. The system also includes a processing agent, wherein the processing agent includes data availability testing means adapted for testing availability of data prior to each of a the series of discrete processing stages and capacity testing means adapted for testing processing capacity at each of the series of discrete processing stages. The system further comprises means adapted for selectively moving data associated with each at least one electronic document to successive processing stages in accordance with an output of the data availability testing means and the capacity testing means. The system also comprises means adapted for outputting data associated with each at least one electronic document upon completion of a series of discrete processing steps thereon.

Still further, in accordance with the subject application, there is provided a method for pipelined dataflow document processing. The method receives job data inclusive at least one electronic document directed to processing on a selected document processing device and processes each received electronic document in a series of discrete processing stages. The method tests availability of data prior to each of the series of discrete processing stages and processing capacity at each of the series of discrete processing stages. The method then selectively moves data associated with each at least one electronic document to successive processing stages in accordance with an output of the testing of availability of data and processing capacity and outputting data associated with each at least one electronic document upon completion of a series of discrete processing steps thereon.

Preferably, the processing agent is comprised of XML descriptors.

In one embodiment, at least one processing stage is completed in connection with storage of associated data in a nonvolatile storage and at least one processing stage is completed in connection with storage of associated data in a volatile storage. The system and method also receive an interrupt signal representative of an interrupt between flow of data between processing stages and commence a restart of processing of associated data for each at least one electronic document at a last stage wherein associated data is in a nonvolatile storage.

In another embodiment, the system and method include the ability to selectively commence parallel operations associated with received job data and synchronize parallel operations so as to result in a document output including results of each of the parallel operations. Preferably, one parallel operation includes an output medium handling operation. Also, preferably, the parallel operations are synchronized so that output of processed electronic document data from the series of processing stages is synchronized with operation of the output medium handling operation after receipt of an interrupt.

In one other embodiment, the system and method generate a graphical output representative of the series of discrete processing stages to an associated user.

In yet another embodiment, the system and method also include constructing the series of discrete processing stages in accordance with input received from an associated user.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

The subject application is described with reference to certain figures, including:

FIG. 1 which is an overall system diagram of the system for pipelined dataflow document processing according to the subject application;

FIG. 2 is a block diagram illustrating controller hardware for use in the system for pipelined dataflow document processing according to the subject application;

FIG. 3 is a functional block diagram illustrating the controller for use in the system for pipelined dataflow document processing according to the subject application;

FIG. 4 is a flowchart illustrating the method for the pipelined dataflow document processing according to the subject application;

FIG. 5 is a flowchart illustrating a contemporaneous processing method for the pipelined dataflow document processing according to the subject application; and

FIG. 6 is a flowchart illustrating one embodiment of the pipelined dataflow document processing according to the subject application.

### DETAILED DESCRIPTION OF THE PREFERRED EMBODIMENT

The subject application is directed to a system and method for pipelined dataflow document processing. In particular, the subject application is directed to a system and method for synchronized parallel pipelined document processing wherein such processing is more efficient and more fault tolerant. More particularly, the subject application is directed to a system and method for pipelined dataflow document processing that is robust and can recover from interrupts, as well as efficiently use parallel processing in an efficient manner.

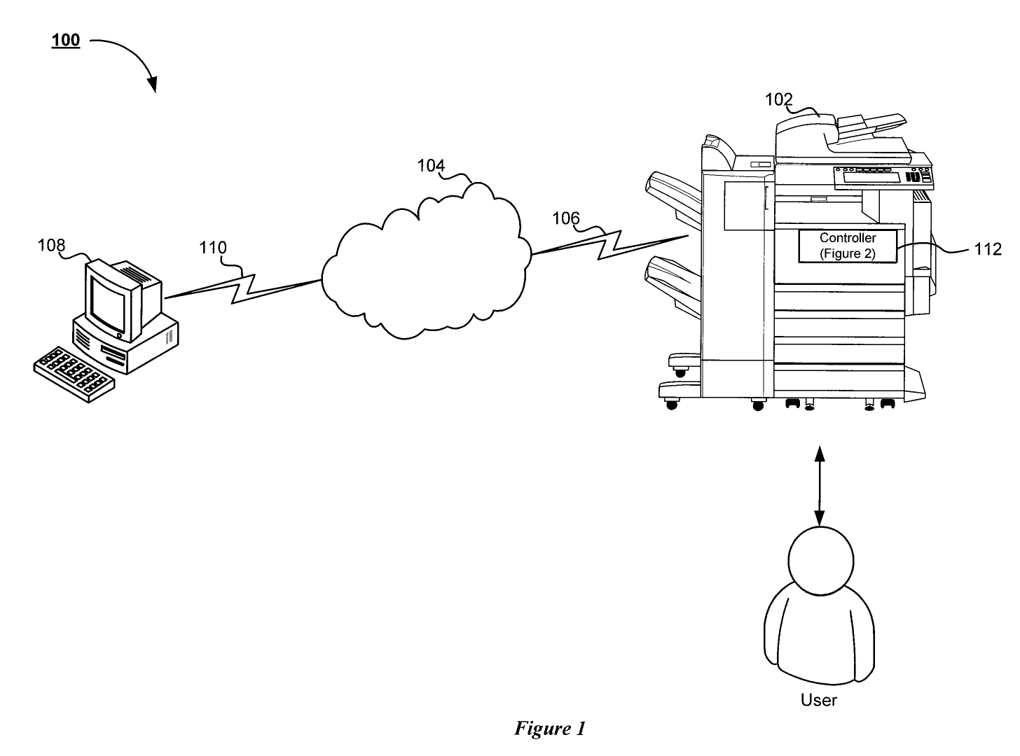

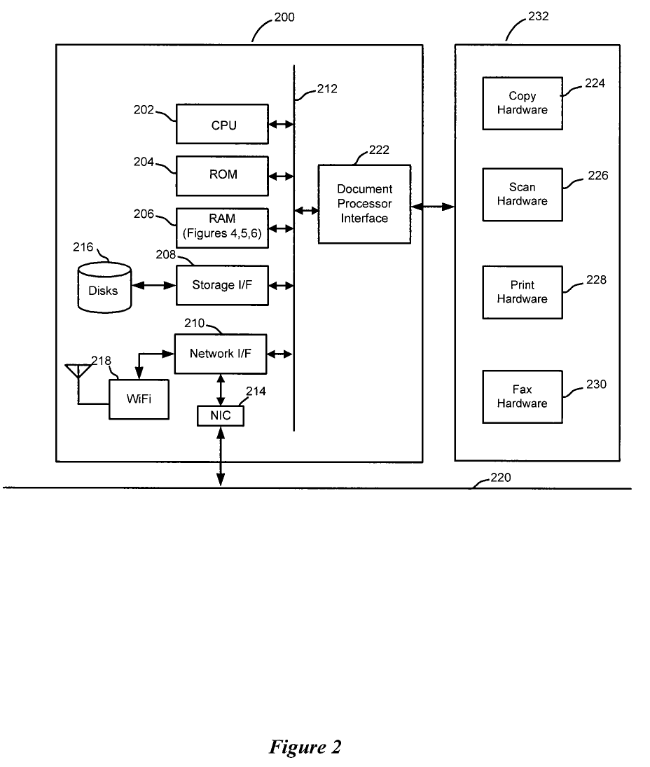

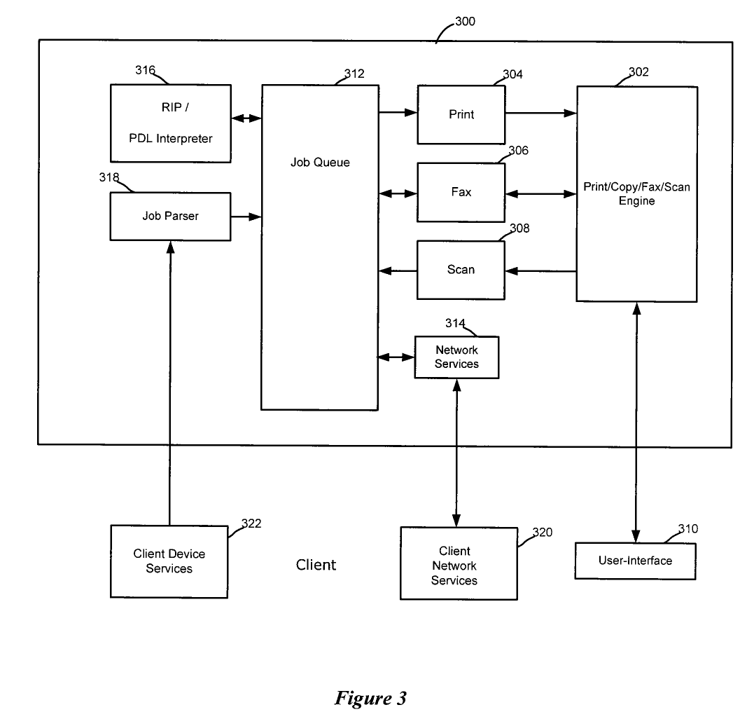

Referring now to FIG. 1, there is shown a block diagram illustrating a system 100 for pipelined dataflow document processing in accordance with the subject application. As shown in FIG. 1, the system 100 includes a document processing device 102, represented as the multifunction peripheral device 102. It will be understood by those skilled in the art the document processing device 102 is suitably adapted to provide a variety of document processing services, such as, for example and without limitation, electronic mail, scanning, copying, facsimile, document management, printing, and the like. Suitable commercially available document rendering devices include, but are not limited to, the Toshiba e-Studio Series Controller. In one embodiment, the document processing device 102 is suitably equipped to receive a plurality of portable storage media, including without limitation, Firewire drive, USB drive, SD, MMC, XD, Compact Flash, Memory Stick, and the like. In the preferred embodiment of the present invention, the document processing device 102 further includes an associated user-interface, such as a touch-screen interface, LCD display, or the like, via which an associated user is able to interact directly with the document processing device 102. In accordance with the subject application, the document processing device 102 further incorporates a controller 112, suitably adapted to facilitate the operations of the document processing device 102, as will be understood by those skilled in the art. Preferably, the controller 112 is embodied as hardware, software, or any suitable combination thereof, configured to control the operations of the associated document processing device 102, control the display of images via the user-interface, and the like. The functioning of the controller 112 will better be understood in conjunction with the block diagrams illustrated in FIGS. 2 and 3, explained in greater detail below.

The system 100 illustrated in FIG. 1 also includes a distributed computing environment, represented as a computer network 104. It will be appreciated that the computer network 104 is any distributed communications environment known in the art capable of allowing two or more electronic devices to exchange data. The skilled artisan will understand that the computer network 104 is any computer network, known in the art, including, for example and without limitation, a local area network, a wide area network, a personal area network, a virtual network, the Internet, or any combination thereof. In the preferred embodiment, the network 104 is comprised of physical layers and transport layers, as illustrated by a myriad of conventional data transport mechanisms, including, for example and without limitation, Ethernet, Token-Ring, 802.11(x), or other wire-based or wireless data communication mechanisms.

In accordance with one aspect of the subject application, the document processing device 102 is in data communication with the computer network 104 via a suitable communications link 106. As will be appreciated by the skilled artisan, a suitable communications links 106 employed in accordance with the present invention includes, WiMax, 802.11a, 802.11b, 802.11g, 802.11(x), Bluetooth, the public switched telephone network, a proprietary communications network, infrared, optical, or any other suitable wired or wireless data transmission communications known in the art.

The system 100 depicted in FIG. 1 further includes at least one client device 108. Preferably, the client device 108 is communicatively coupled to the computer network 104 via a suitable communications link 110. It will be appreciated by those skilled in the art that the client device 108 is depicted in FIG. 1 as a personal computer for illustration purposes only. As the skilled artisan will understand, the client device 108 shown in FIG. 1 is representative of any personal computing device known in the art, including, for example and without limitation, a computer workstation, a laptop computer, a personal data assistant, a web-enabled cellular telephone, a smart phone, or other web-enabled electronic device suitably capable of generating and/or transmitting electronic document data to a multifunctional peripheral device. Communication between the client device 108 and the computer network 104 is advantageously accomplished via the communications link 110. The communications link 110 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. In the preferred embodiment, the client device 108 is suitably adapted to generate an electronic document using any document or image generating application known in the art.

Turning now to FIG. 2, illustrated is a representative architecture of a suitable controller 200, shown as the controller 112 in FIG. 1, on which operations of the subject system 100 are completed. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. Network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and network interface subsystem 210 is suitably accomplished via a bus data transfer mechanism, such as illustrated by bus 212.

Also in data communication with bus 212 is a document processor interface 222. Document processor interface 222 suitably provides connection with hardware to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that a controller suitably operates any or all of the aforementioned document processing operations. Systems accomplishing more than one document processing operation are commonly referred to as multifunction peripherals or multifunction devices.

Functionality of the subject system 100 is accomplished on a suitable document processing device that includes the controller 200 of FIG. 2, illustrated as the controller 112 in FIG. 1, as an intelligent subsystem associated with a document processing device. In the illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably via an interface local to the controller, or remotely via a remote thin or thick client.

The engine 302 is in data communication with printer function 304, facsimile function 306, and scan function 308. These devices facilitate the actual operation of printing, facsimile transmission and reception, and document scanning for use in securing document images for copying or generating electronic versions.

A job queue 312 is suitably in data communication with printer function 304, facsimile function 306, and scan function 308. It will be appreciated that various image forms, such as bit map, page description language or vector format, and the like, are suitably relayed from scan function 308 for subsequent handling via job queue 312.

The job queue 312 is also in data communication with network services 314. In a preferred embodiment, job control, status data, or electronic document data is exchanged between job queue 312 and network services 314. Thus, suitable interface is provided for network based access to the controller 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. Network services 314 also advantageously supplies data interchange with client side services 320 for communication via FTP, electronic mail, TELNET, or the like. Thus, the controller function 300 facilitates output or receipt of electronic document and user information via various network access mechanisms.

Job queue 312 is also advantageously placed in data communication with an image processor 316. Image processor 316 is suitably a raster image process, page description language interpreter or any suitable mechanism for interchange of an electronic document to a format better suited for interchange with device services such as printing 304, facsimile 306 or scanning 308.

Finally, job queue 312 is in data communication with a parser 318, which parser suitably functions to receive print job language files from an external device, such as client device services 322. Client device services 322 suitably include printing, facsimile transmission, or other suitable input of an electronic document for which handling by the controller function 300 is advantageous. Parser 318 functions to interpret a received electronic document file and relay it to a job queue 312 for handling in connection with the afore-described functionality and components.

In operation, according to the preferred embodiment of the subject application, electronic document data is generated via any suitable means and incorporated into a document processing request, i.e., a job request. As will be understood by those skilled in the art, the job request is capable of requesting any of the various document processing services provided by the document processing device 102, including, for example and without limitation, a copy request, a facsimile request, a print request, or the like. The skilled artisan will further appreciate that the job request is capable of originating remotely, via the client device 108, or locally via the user-interface associated with the document processing device 102. Preferably, the document processing request includes data representing the selected document processing operation. In accordance with one embodiment of the subject application, the document processing request further includes, but is not limited to, document data representative of a document to be processed by the document processing device 102.

When the controller 112 associated with the document processing device 102 receives the document processing request, either indirectly from the client device 108, or from an associated user, the processing operation corresponding to the request is parsed, or split, into a series of discrete stages. As will be appreciated by those skilled in the art, each stage represents a distinct step in the processing of the document processing request. In accordance with one aspect of the subject application, the user requesting the document processing operation is able to select the order for stage processing using a graphical user-interface, implemented via the client device 108 or the user-interface associated with the document processing device 102, from which the controller 112 directs operations of the document processing device 102. For example, and without limitation, when the document processing request corresponds to a copy operation, stages are capable of including, scanning, output medium feeding, image processing, output medium travel, image formation on photosensitive drum, image transference to output medium, and the like. In accordance with one particular embodiment of the subject application, the controller 112, following division of the job into stages, determines a sequence corresponding to the order in which the distinct stages are to be performed.

The controller 112 associated with the document processing device 102 then initiates the first stage associated with the document processing request and makes a determination whether or not contemporaneous processing of stages is available. That is, the controller 112 determines whether or not one or more stages, in addition to the first stage, are capable of being performed concurrently. In order to facilitate this contemporaneous processing, the skilled artisan will appreciate that the controller 112 assembles a complex network of pipes through which data flows. As will be understood by those skilled in the art, the pipes are formed using conventional storage mechanisms, comprising a reader and a writer. The pipes further include notification mechanisms suitably adapted to notify readers and writers of activity, thereby enabling the synchronized transfer of data between processes, e.g., stages. Preferably, the subject application employs various agents placed in a network of parallel pipes connected to each other at various points through first-in-first-out pipes. Further in accordance with the subject application, the agents are disjointed, thereby allowing for the extension and reconfiguring of the workflow at runtime. Thus, complete pipeline can be build by describing connections via an XML descriptor. The foregoing usage of pipes will better be understood as discussion continues hereinafter with the function of the system 100. In accordance with one aspect of the subject application, the user is able to view the processing of the stages via output to a graphical user-interface suitably displayed via the user-interface associated with the document processing device 102 or the client device 108.

When it is determined that contemporaneous processing of stages is available, the controller 112 associated with the document processing device 102 initiates the contemporaneous stage, or stages. The controller 112 associated with the document processing device 102 then processes the data associated with each stage in accordance with the process corresponding to that stage. The processed data is then stored, for example and without limitation, in a volatile storage medium, such as RAM. The controller 112 then determines whether any additional stages remain to be processed, e.g., stages that require the output of processed data from a preceding stage. When contemporaneous processing has been invoked, the controller 112 must first determine whether the resulting data needs to be merged before proceeding with the next stage of the document processing operation. When the data does need to be merged, the controller 112 associated with the document processing device 102 combines the output of the contemporaneous stages via any suitable means known in the art and then determines whether the operation is ready to proceed to the next stage. When the operation is not ready to proceed to the next stage, the output data from the preceding stage or stages is stored in non-volatile memory until such time as the next stage is ready.

When the next stage of the document processing operation is ready to perform its associated processing operation, the data from the preceding stage or stages is moved to the next stage for further processing as set forth above. When the next stage of the document processing operation is ready, i.e., the data is available for processing and capacity exists to perform and store such results (enough RAM is free), the data is moved to the next stage in the sequence and operation of the document processing device 102 continues as set forth above.

In the context of the pipes referenced above, the controller 112 first determines whether the data is available in the read-side portion of the pipe and whether capacity exists in the write-side portion of the pipe to receive the processed data. This processing proceeds for each stage of the document processing operation until all stages have been completed. The data resulting from the processing by all stages is then merged together, when necessary, to produce output data, whereupon the requested document processing operation is completed. To state another way, once all stages have been completed, the output data from those stages is combined to generate the output document data necessary to complete the requested document processing operation.

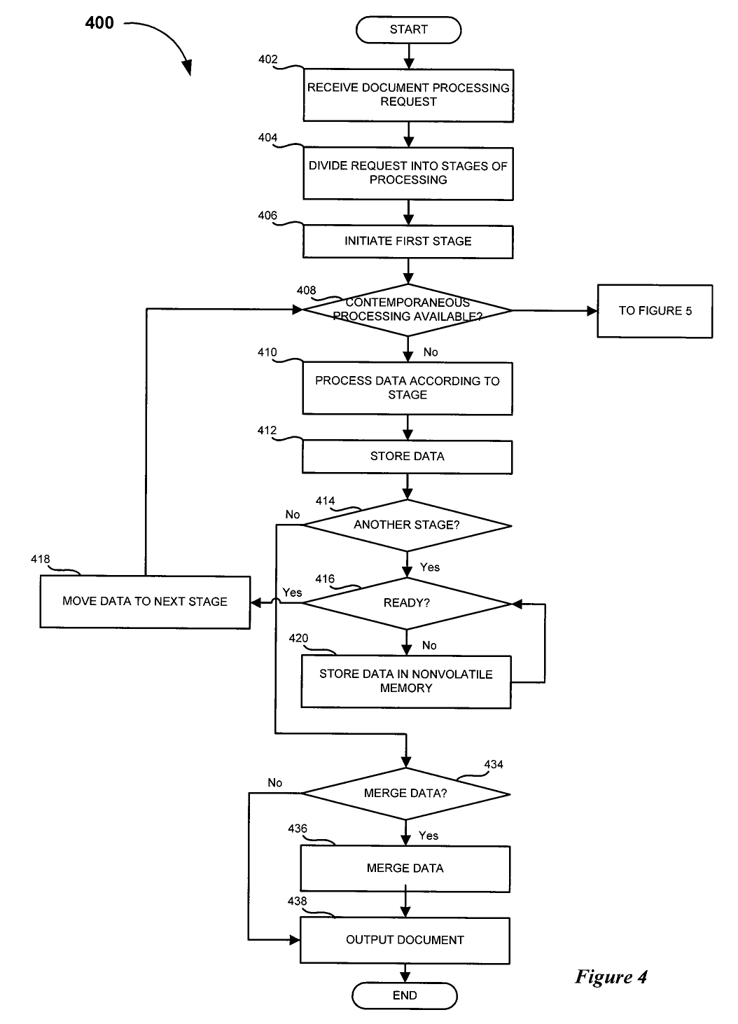

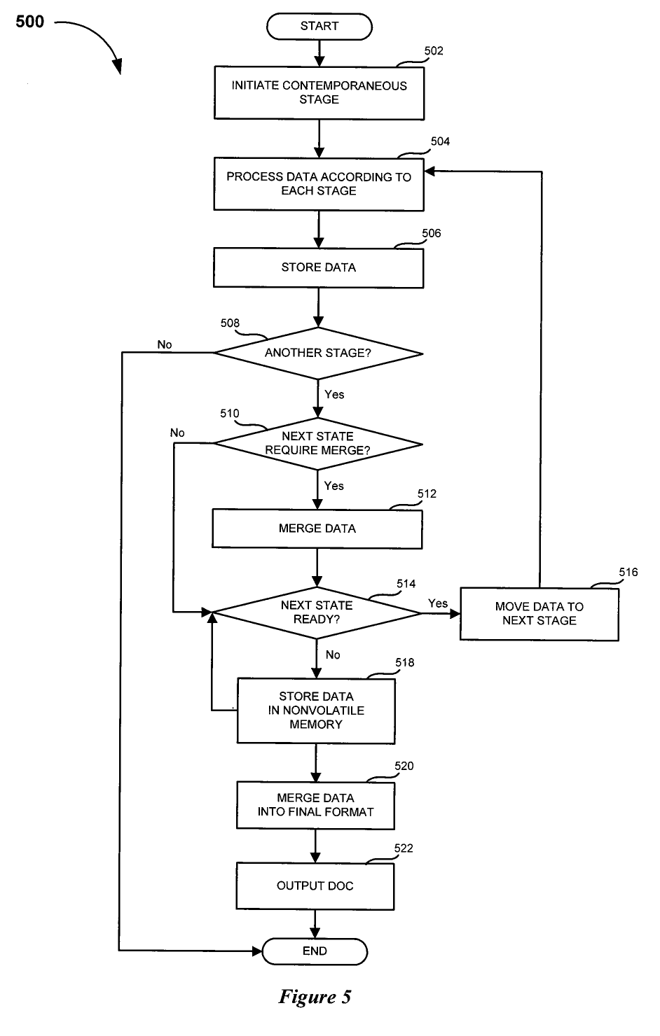

The skilled artisan will appreciate that the foregoing description highlights the ability of the subject application to perform any number of stages concurrently, limited by the availability of the data associated with that stage and processing capabilities available for the performance of that stage. The system 100 described above with respect to FIGS. 1, 2, and 3, will better be understood in conjunction with the methodology described in FIGS. 4 and 5. Turning first to FIG. 4, there is shown a flowchart 400 illustrating a method for the pipelined dataflow document processing in accordance with the subject application. Beginning at step 402, the document processing device 102 receives a document processing request from an associated user. Preferably, the document processing request includes electronic document data, or in the alternative, instructions to generate electronic document data, such as, for example, electornic image data from a scanning operation. In accordance with one aspect of the subject application, the document processing request is generated at the client device 108 and transmitted, via the computer network 104, to the document processing device 102. According to another aspect of the subject application, the document processing request is received from the associated user via the user-interface located at the document processing device 102. The skilled artisan will appreciate, for example, that a document processing request originating from the client device 108 is represented as a print job, whereas the user-interface originating document processing device is represented as a copy job.

Irrespective of the origin of the document processing request, the controller 112 associated with the document processing device 102 then, at step 404, divides the request in a sequence of discrete events, or stages, which when all performed constitute the completion of the document processing request. Preferably, the controller 112 determines an appropriate sequence or order in which the stages are to be performed, detailing those stages capable of concurrent performance, those stages that are dependent upon preceding stages, and those stages that require full use of the processing capabilities of the document processing device 102, preventing other stages from being concurrently processed. In accordance with one aspect of the subject application, a user, via a suitable graphical user-interface at the document processing device 102 or the client device 108, selects an order for the processing of stages. Regardless of whether the stage processing order is determined automatically by the controller 112 or the user requesting the document processing operation, the controller 112 uses this order to determine, at step 406, the first stage to be initiated, thereby beginning the document processing operation. In accordance with one aspect of the subject application, the user is able to view the processing of the stages via output to a graphical user-interface suitably displayed via the user-interface associated with the document processing device 102 or the client device 108.

The controller 112 associated with the document processing device 102 then determines, at step 408, whether contemporaneous processing of stages is available. That is, the controller 112 determines whether one or more additional stages are capable of being performed concurrently with the first stage. When contemporaneous processing of stages is available, operations proceed from step 408 of FIG. 4 to the flowchart 500 of FIG. 5, the methodology of which is discussed in detail below. When contemporaneous processing of stages is not available, flow proceeds to step 410, whereupon the document data or the instruction to generate electronic image data, is performed. The skilled artisan will appreciate that step 410 instructs, in the case of a copy or scan job, for example, the document processing device 102 to perform a scanning operation to generate electronic image data. The skilled artisan will further appreciate that step 410 instructs the document processing device 102, in the case of a print job, for example, to begin the first stage of processing the electronic image data received from the client device 108, or from a portable storage medium inserted by the associated user. The data processed at step 410 is then stored in a volatile memory location, such as RAM, at step 412. A determination is then made at step 414 whether another stage remains to be performed.

When no additional stages remain to be performed, flow proceeds to step 422, whereupon a determination is made whether the data generated during the preceding stage or stages must be merged to form the final output data. A positive determination at step 422 prompts flow to proceed to step 424, at which the data is merged and final output data is generated. The document is then output at step 426. When a negative determination is made at step 422, flow proceeds directly to step 426, whereupon the document is output in accordance with the requested document processing operation.

When an additional stage is required, flow proceeds to step 416, whereupon the controller 112 determines whether the next stage is ready to perform. It will be appreciated by those skilled in the art that such a ready determination equates to the controller 112 associated with the document processing device 102 determining that the data for the next stage is available and that the capacity to perform the next stage is available on the document processing device 102. It will further be appreciated by the skilled artisan that the controller 112 continues to periodically check to determine if the process is ready to proceed to the next stage of processing. A negative determination, such as an interrupt mechanism or signal received at step 416 results in the storage of the data from the preceding stage in non-volatile memory at step 420, where it remains until such time as the document processing device 102 is ready to perform the next stage of the document processing operation. When a ready signal, i.e., a positive determination, is recognized by the controller 112 associated with the document processing device 102, the data is moved to the next stage for processing in accordance therewith. Flow then returns to the determination of contemporaneous processing at step 408.

Turning now to FIG. 5, there is shown a flowchart 500 illustrating a method for contemporaneous processing in accordance with the subject application. It will be understood by those skilled in the art that when it is determined at step 408 of FIG. 4 that contemporaneous processing is available, flow proceeds to step 502 of FIG. 5. Beginning at step 502, the one or more stages capable of contemporaneous processing are initialized. The data is then processed at step 504 in accordance with the specific processing functions of the one or more additional stages and is stored in volatile memory at step 506. It will be appreciated by those skilled in the art that while volatile memory is used in the preferred embodiment, the subject application is capable of using any non-volatile memory, known in the art, to store the processed data prior to the initiation of any subsequent stages of processing. A determination is then made at step 508 whether any additional stages remain to be performed. When no additional stages remain, flow proceeds to step 520, whereupon the contemporaneous stage processed data is merged into a final output format. The document is then output in accordance with the requested document processing operation at step 522. In accordance with one aspect of the subject application, the user is able to view the processing of the stages via output to a graphical user-interface suitably displayed via the user-interface associated with the document processing device 102 or the client device 108.

A determination at step 508 that one or more additional stages remain for processing prompts flow to proceed to step 510. At step 510, a determination is made whether the processed data, from the contemporaneous stage, must be merged before subsequent stage processing. That is, the controller 112 determines at step 510 whether the next stage in the processing requires data processed by previous stages to be merged. When the data is to be merged, flow proceeds to step 512, whereupon the data from the one or more contemporaneous processes is merged. The controller 112 associated with the document processing device 102 then determines, at step 514, whether the next stage is ready to process the data. The skilled artisan will appreciate that the next stage in processing is based on the division of stages as set forth at step 404 of FIG. 4. When the next stage is not ready to begin processing of the data, i.e., when an interrupt mechanism or signal received at step 514, flow proceeds to step 518, whereupon the data is stored in non-volatile memory until such time as the next stage is ready. That is, the data is stored in the non-volatile memory when the pipe associated with the next process is able to receive the data and has adequate write capacity to receive the data after processing by that next stage. Preferably, the controller 112 receives a ready signal, or rather periodically checks for such signal or notification, to determine whether the next stage is ready to receive the processed data. When the next stage is ready, the data is moved to that stage at step 516 and flow returns to step 504 for contemporaneous processing. Returning to step 510, when the data does not need to be merged before continuing to the next stage, flow proceeds directly to step 514 for a ready determination by the controller 112 associated with the document processing device 102.

Operations continue in accordance with the methodology described above until such time as a determination is made at step 508 that no additional stages remain for processing. When such a determination is made by the controller 112 associated with the document processing device 102, flow proceeds to step 520, whereupon the data resulting from the processing at the contemporaneous stages is merged into a final output format. Thereafter, flow progresses to step 522, at which the document processing device 102 outputs the document.

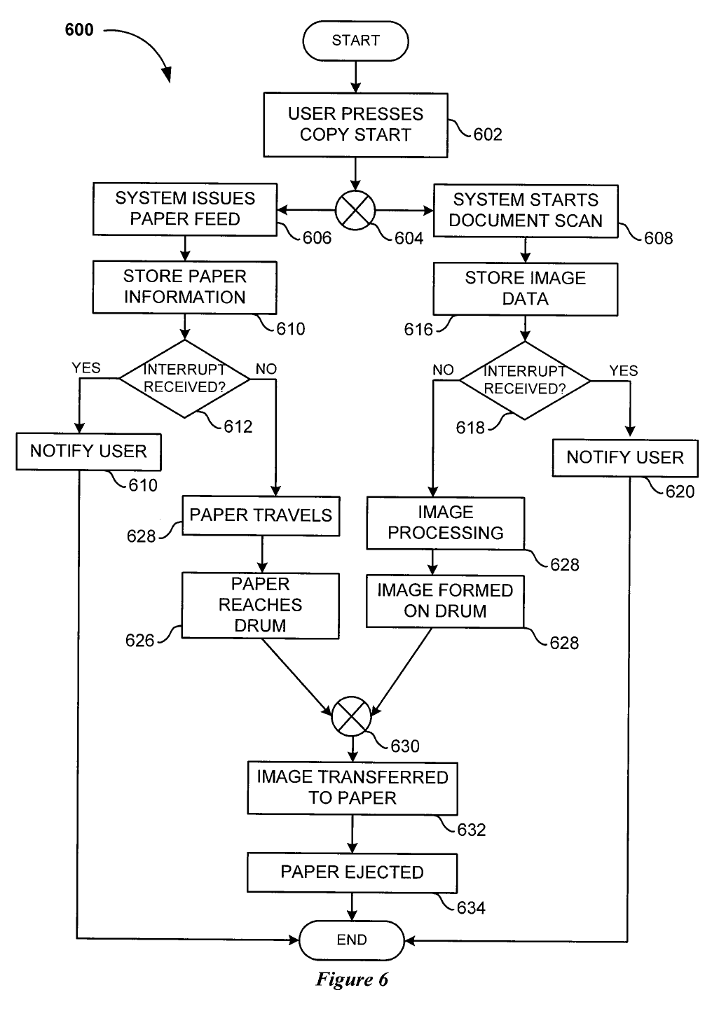

The method and system described above with respect to FIGS. 1, 2, 3, 4, and 5 will better be understood in conjunction with an example implementation of the present invention, as shown in FIG. 6. FIG. 6 illustrates a copy job processing operation 600 in accordance with the present invention. At step 602, an associated user initiates a copy job operation, wherein a hardcopy representation of a document is placed on an automated document feeder or on a scanning bed, as will be understood by those skilled in the art. At step 604, the copy job is divided into a sequence of discrete stages and contemporaneous processing is available. Accordingly, flow proceeds from step 604 to steps 606 and 608 concurrently. At step 606, paper feeding of the output paper is begun while the scanning unit of the document processing device 102 begins scanning the hardcopy document to generate electronic image data at step 608. During these respective steps, the controller 112 is continuously monitoring the processing for any interrupt signal and storing image data and paper location data in non-volatile memory.

Thus, following step 606, flow proceeds to step 610, whereupon paper information, such as paper location data, page count data, jam status, and the like, is stored in non-volatile memory. A determination is then made at step 612 whether an interrupt signal has been received, i.e., a paper jam, multiple sheets retrieved, or the like. When an interrupt signal is received, flow proceeds to step 614, whereupon the user is notified of the interrupt and the operation terminates until restarted, using the stored data to reinitiate the process. When no interrupt signal is detected during processing at step 612, flow progresses to the next stage of processing, i.e., the paper travels at step 622. Similarly, the controller 112 directs the storage of image data generated during step 608 at step 616 in non-volatile memory. A determination is then made at step 618 whether an interrupt signal has been received by the controller during processing at step 608. When an interrupt signal, such as a processing error, scanning error, or the like, is received at step 618, flow proceeds to step 620, whereupon the user is notified of the error and the operation terminates until reinitiated using the previously stored data. When no interrupt is received, flow proceeds from step 620 to step 624, i.e., the next stage of processing.

The paper travels at step 622 while the electronic image data is processed at step 624. It will be understood by those skilled in the art that the controller 112 stores the paper information and image data in non-volatile memory against the possibility of the receipt of an interrupt signal following each successive stage of processing. Although not illustrated in FIG. 6, the skilled artisan will understand that steps 610-614 and 616-620 are repeated following each processing stage shown in FIG. 6. Thus, during the processing of step 622, steps 610-614 are performed by the controller 112 and simultaneously during the processing of step 624, steps 616-620 are performed by the controller 112. The paper reaches the photosensitive drum of the document processing device 102 at step 626 concurrently with the formation of the image on the drum at step 628. During performance of the processing of steps 626 and 628, the skilled artisan will appreciate that steps 610-614 and 616-618, respectively, are performed by the controller 122. The data is then merged at step 630, i.e., the concurrent processing ends and flow proceeds to step 632, whereupon the image on the photosensitive drum is transferred to the output medium, via any suitable means known in the art. The paper is then ejected at step 634, thereby completing the copy operation. In accordance with one aspect of the subject application, the user is able to view the processing of the stages via output to a graphical user-interface suitably displayed via the user-interface associated with the document processing device 102 or the client device 108.

The subject application extends to computer programs in the form of source code, object code, code intermediate sources and object code (such as in a partially compiled form), or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject matter and its practical application to thereby enable one of ordinary skill in the art to use the invention in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A pipelined dataflow document processing system comprising:
means adapted for receiving job data inclusive of at least one electronic document directed to processing on a selected document processing device;
a processing pipeline adapted for processing each received electronic document in a series of discrete processing stages;
a processing agent including,
data availability testing means adapted for testing availability of data prior to each of a the series of discrete processing stages, and
capacity testing means adapted for testing processing capacity at each of the series of discrete processing stages;
means adapted for selectively moving data associated with each at least one electronic document to successive processing stages in accordance with an output of the data availability testing means and the capacity testing means; and
means adapted for outputting data associated with each at least one electronic document upon completion of a series of discrete processing steps thereon.

2. The pipelined dataflow document processing system of claim 1 wherein at least one processing stage is completed in connection with storage of associated data in a nonvolatile storage and wherein at least one processing stage is completed in connection with storage of associated data in a volatile storage, and wherein the system further comprises:
means adapted for receiving an interrupt signal representative of an interrupt between flow of data between processing stages; and
restart means adapted for commencing a restart of processing of associated data for each at least one electronic document at a last stage wherein associated data is in a nonvolatile storage.

3. The pipelined dataflow document processing system of claim 1 further comprising:
means adapted for selectively commencing parallel operations associated with received job data; and wherein
the processing agent includes means adapted for synchronizing parallel operations so as to result in a document output including results of each of the parallel operations.

4. The pipelined dataflow document processing system of 3 wherein a first parallel operation includes an output medium handling operation.

5. The pipelined dataflow document processing system of claim 4 wherein at least one processing stage is completed in connection with storage of associated data in a nonvolatile storage and wherein at least one processing stage is completed in connection with storage of associated data in a volatile storage, and wherein the system further comprises:
means adapted for receiving an interrupt signal representative of an interrupt between flow of data between processing stages;
restart means adapted for commencing a restart of processing of associated data for each at least one electronic document at a last stage wherein associated data is in a nonvolatile storage; and wherein
the processing agent includes means adapted for synchronizing parallel operations so that output of processed electronic document data from the series of processing stages is synchronized with operation of the output medium handling operation after receipt of an interrupt.

6. The pipelined dataflow document processing system of claim 1 wherein the processing agent is comprised of XML descriptors.

7. The pipelined dataflow document processing system of claim 6 further comprising means adapted for generating a graphical output representative of the series of discrete processing stages to an associated user.

8. The pipelined dataflow document processing system of claim 1 further comprising means adapted for constructing the series of discrete processing stages in accordance with input received from an associated user.

9. A pipelined dataflow document processing method comprising the steps of:
receiving job data inclusive of at least one electronic document directed to processing on a selected document processing device;
processing each received electronic document in a series of discrete processing stages;
testing availability of data prior to each of a the series of discrete processing stages;
testing processing capacity at each of the series of discrete processing stages;
selectively moving data associated with each at least one electronic document to successive processing stages in accordance with an output of the testing of availability of data and processing capacity; and
outputting data associated with each at least one electronic document upon completion of a series of discrete processing steps thereon.

10. The pipelined dataflow document processing method of claim 9 wherein at least one processing stage is completed in connection with storage of associated data in a nonvolatile storage and wherein at least one processing stage is completed in connection with storage of associated data in a volatile storage, and wherein the method further comprises the steps of:
receiving an interrupt signal representative of an interrupt between flow of data between processing stages; and
commencing a restart of processing of associated data for each at least one electronic document at a last stage wherein associated data is in a nonvolatile storage.

11. The pipelined dataflow document processing method of claim 9 further comprising the steps of:
selectively commencing parallel operations associated with received job data; and
synchronizing parallel operations so as to result in a document output including results of each of the parallel operations.

12. The pipelined dataflow document processing method of 11 wherein a first parallel operation includes an output medium handling operation.

13. The pipelined dataflow document processing method of claim 12 wherein at least one processing stage is completed in connection with storage of associated data in a nonvolatile storage and wherein at least one processing stage is completed in connection with storage of associated data in a volatile storage, and wherein the method further comprises the steps of:
receiving an interrupt signal representative of an interrupt between flow of data between processing stages;
commencing a restart of processing of associated data for each at least one electronic document at a last stage wherein associated data is in a nonvolatile storage; and
synchronizing parallel operations so that output of processed electronic document data from the series of processing stages is synchronized with operation of the output medium handling operation after receipt of an interrupt.

14. The pipelined dataflow document processing method of claim 9 wherein the processing agent is comprised of XML descriptors.

15. The pipelined dataflow document processing method of claim 14 further comprising the step of generating a graphical output representative of the series of discrete processing stages to an associated user.

16. The pipelined dataflow document processing method of claim 9 further comprising the step of constructing the series of discrete processing stages in accordance with input received from an associated user.

17. A computer-implemented method for pipelined dataflow document processing comprising the steps of:
receiving job data inclusive of at least one electronic document directed to processing on a selected document processing device;
processing each received electronic document in a series of discrete processing stages;
testing availability of data prior to each of a the series of discrete processing stages;
testing processing capacity at each of the series of discrete processing stages;
selectively moving data associated with each at least one electronic document to successive processing stages in accordance with an output of the testing of availability of data and processing capacity; and
outputting data associated with each at least one electronic document upon completion of a series of discrete processing steps thereon.

18. The computer-implemented method for pipelined dataflow document processing of claim 17 wherein at least one processing stage is completed in connection with storage of associated data in a nonvolatile storage and wherein at least one processing stage is completed in connection with storage of associated data in a volatile storage, and wherein the method further comprises the steps of:
receiving an interrupt signal representative of an interrupt between flow of data between processing stages; and
commencing a restart of processing of associated data for each at least one electronic document at a last stage wherein associated data is in a nonvolatile storage.

19. The computer-implemented method for pipelined dataflow document processing of claim 17 further comprising the steps of:
selectively commencing parallel operations associated with received job data; and
synchronizing parallel operations so as to result in a document output including results of each of the parallel operations.

20. The computer-implemented method for pipelined dataflow document processing of claim 17 further comprising the step of constructing the series of discrete processing stages in accordance with input received from an associated user.
